(19) United States
(12) Patent Application Publication
(10) Pub. No.: US 2004/0162830 A1
(43) Pub. Date: Aug. 19, 2004

(54) Method and system for searching location based information on a mobile device

(76) Inventors: Sanika Shirwadkar, Edison, NJ (US); Sameer Yami, Edison, NJ (US)

Correspondence Address: DEMONT & BREYER, LLC, SUITE 250, 100 COMMONS WAY, HOLMDEL, NJ, 07733, US

(21) Appl. No.: 10/777,237

(22) Filed: Feb. 12, 2004

Related U.S. Application Data
(60) Provisional application No. 60/448,634, filed on Feb. 18, 2003.

(51) Int. Cl. G06F 17/30

(52) U.S. Cl. 707/10

(57) ABSTRACT

A method and system for searching location based information on a mobile device is disclosed. The method and system provides for location based resource information retrieval, processing retrieved resource information based on probability of finding them in the given location, a Peer to Peer recommendation system that combines other user's real time recommendations with archived recommendations, a virtual social network that creates a dynamic network consisting of user and user's acquaintances for refining the resource information, providing a refined set of search results, by considering user's privacy choices and personal preferences.

### FIELD OF THE INVENTION

The present invention relates generally to computer software systems. In particular, an embodiment of the invention relates to a method and system for providing location based search capabilities to a mobile device user.

### BACKGROUND OF THE INVENTION

Location Based Services are used to provide a mobile device user with the information based on the current location of the user. The services are generally used for 911 (Emergency Operations) that are used by the Police and traffic departments to report and handle any emergencies. The procedure for reporting the emergencies is through the mobile device operator or through a GPS service available in the mobile device (that may itself be installed in a vehicle etc.), where the device is first located by the mobile operator and then its information is communicated to the relevant authorities. In this type of location based service, emergency help is the main service that is provided.

In a more advanced version, the location based service is used to locate the location of critical deliverables in a supply chain management or in postal services. Algorithms and systems also exist that detect the location of critical machines such as yachts in the deep sea. Such systems are used extensively in the fishing industry. The information provided to the user in all these instances is using push technology since critical information is communicated to the user from the service operator. Also, these services provide user with the information that is not very detailed, so usually, the user cannot make use of this information for non-critical operations such as looking for a specific product/person in a specific geographical area, etc.

In a more networked world, where there are many services provided by various government and private agencies, it is possible to provide much more location based information to the mobile user. This is used extensively in telematics such as in GPS (Geographical Positioning Systems) receivers that are used in vehicles. These services provide information about the nearby places of interest (tourist places, gas stations, restaurants, etc.) and their directions.

In another version, in a location based service that acts as an Internet search engine, a web robot gathers web documents from the Internet, parses and extracts address strings from these documents and associates latitude-longitude information with the original document. This system then can retrieve location-based web documents when the location information is provided. Similarly, there are systems available that get information about different Web Services from servers located on the web and then query these Web Services about available products.

### SUMMARY OF THE INVENTION

However, all these systems lack the ability to provide more detailed search capabilities for searching information related to various resources that may be available in the various locations and providing comparisons and recommendations for all the available products in real time. In addition, a user is not capable of searching information about a resource (hereby ‘resource’ is used to denote but not limited to a product, a product category, a person, a tourist place, an organization, geographic location or other variations, and will be used hereafter) in a given location and/ or obtain approval from similar minded people or people who have used the resource earlier without going through large amount of data and recommendations that may not be even relevant. Accordingly, a need exists for a method and system which provides location based search capabilities to a mobile device user. Embodiments of the present invention provide a method and system that accomplishes the above-mentioned need.

For instance, one embodiment of the present invention provides a method and system for pre-calculating probabilities of finding various resources in a location, and using these probabilities in searching the resources. These probabilities are calculated periodically by querying the relevant services provided by the resource information providers (retail stores, tourist places, organizations, etc.). The different probabilities are calculated for—the physical presence of the resource in the specified location, the presence of the resource category in the specified location, the cross probabilities (the probability that a resource exists in a particular category, given a certain non-zero probability for another category), etc. The actual probabilities may be calculated using Bayesian probability formula or by any other statistical/Artificial Intelligence/data mining method. These individual probabilities are used to calculate the actual probability of finding a resource in a given location. In another embodiment, the search results are sorted and displayed based on their numeric probability in the given location.

In one embodiment, a virtual social network of people is dynamically created based on factors such as the searched resource, user's Interests and past interactions with other users (of similar background or with interest in the searched resource). Relationship between any two users in this social network is quantified with a ‘trust metric’ that gets updated with every transaction. Thus, the virtual social network consists of a user's current network of friends/relatives/acquaintances and users with similar interests. In a related embodiment, the user can choose the people who comprise the social network for a particular resource or it can be selected by a computer program. The users in this social network can be chosen either by the user (who has initiated the search) or by a computer program.

In yet another embodiment, user can specify trust to be limited to a certain value range and limited to certain resource categories. In one embodiment, users within the social network who are having a high level of trust and expertise about a particular resource are chosen to provide the collaborative filter.

In one embodiment, images of a resource are used to assist the user in visualizing the searched resource and thus filtering down the search results.

In another embodiment, web pages are classified based upon the opinion expressed about a particular resource. In a related embodiment, the opinion is obtained by parsing the web page and then establishing a correlation between the resource and the web page. In a related embodiment, the opinion values and the weights associated with them are changed based on the live/stored recommendation values obtained directly from users.

In another embodiment, a resource is first identified as whether it is location dependent or not and then the relevant peer networks or social networks are formed. In another embodiment, both the social network and the peer network are used as Decision support system for a user assisting him/her in making a decision about a resource.

In yet another embodiment, based on the location of the user, a dynamic peer group is created that assists the user in making decisions about the resource by providing live recommendations (if possible—depending on whether other users are available and wish to give live recommendations about that particular resource) or by allowing users to access stored archived recommendations. In a related embodiment, a reward in the form of points or virtual credit/actual credit may be given to the user providing the recommendation. In another related embodiment the user's live recommendations may be combined with the archived recommendations. In yet another related embodiment, the user is provided with a result that combines the most available/popular resource with the most recommended resource that matches the user's interests and preferences.

In another embodiment, resource information is fetched from the Internet, Web Services or manual entries.

In yet another embodiment, the present invention includes a computer-usable medium having computer-readable code embodied therein for causing a computer to perform actions as described above to provide location based searching using a mobile device.

In another embodiment, the location related data is fetched from both the web pages and/or the Web Services provided by the resource information providers (such as retail stores), then assigned probabilities and stored. In another embodiment, a dynamic Peer-to-Peer recommendation system is used to provide resource recommendations to the user after considering user's privacy preferences. These recommendations are combined with the numeric probabilities to provide user with a sorted set of results with the first result being most available and popular and best matching user profile in the current location.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram illustrating various modules in the system for searching location based information on a mobile device in accordance with one embodiment of the present invention.

FIG. 2 is a block diagram illustrating an example of the virtual dynamic social network.

FIG. 3 is a flowchart of steps performed by the search engine in order to prefetch/retrieve search and location data according to one embodiment of the present invention.

FIG. 4 is a flowchart of steps performed by the search system in accordance with one embodiment of the present invention.

FIG. 5 is a flowchart of steps performed by the recommendation (Peer to Peer) system in accordance with one embodiment of the present invention.

FIG. 6 is a block diagram of an embodiment of an exemplary computer system used in accordance with one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components and circuits have not been described in detail as not to unnecessarily obscure aspects of the present invention.

Notation and Nomenclature

Some portions of the detailed descriptions which follow are presented in terms of procedures, logic blocks, processing and other symbolic representations of operations on data bits within a computer system or electronic computing device.

These descriptions and representations are the means used by those skilled in the data processing arts to most effectively convey the substance of their work to others skilled in the art. A procedure, logic block, process, etc., is herein, in generally, conceived to be a self-sequence of steps or instructions leading to a desired result.

The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “generating” or “modifying” or “retrieving” or the like refer to the action and processes of a computer system, or similar electronic computing device that manipulates and transforms data. For example, the data is represented as physical (electronic) quantities within the computer system's registers and memories and is transformed into other data similarly represented as physical quantities within the computer system memories or registers or other such information storage, transmission, or display devices.

Searching Location Based Information on a Mobile Device

The method and system of the present invention provide for the searching of information based on location. According to the exemplary embodiments of the present invention, the system is implemented to suite the requirements of a mobile device user. Thus, according to such embodiments, it is possible to provide search results based on location information, resource availability, resource category (for example: books, music, gift items, least priced, etc.), user interests, other users' recommendations, etc.

According to one embodiment, the resource information is collected from web pages, classified based on the keywords present in the web pages, compressed and stored. According to another embodiment, the resource information is collected from companies' internal databases using companies' provided Web Services or similar Internet based connection end points. According to another embodiment, this information derived from two different sources is combined with location based information and compressed and stored for future reference. According to another embodiment, this information is collected periodically from both the sources and merged with the location information. According to another embodiment, numeric probabilities are assigned to various resources present in various locations.

According to one embodiment, the mobile device user is provided with the search results based on highest probabilities of finding the specified resource in the user's current location. According to another embodiment, the user can dynamically get recommendations from other users that are present in the same location as that of the user. The user can also lookup archived recommendations for the specified resource present in the current location. According to another embodiment, it is possible for the user to provide resource recommendations to other users present in the same location as that of the user, without violation of privacy.

According to another embodiment, the user gets results that are already approved by the social network to which the user belongs. In yet another embodiment, the user is displayed resource images that help in visualizing the exact searched resource and assist the user in refining the searched resource.

Exemplary System in Accordance With Embodiments of the Present Invention

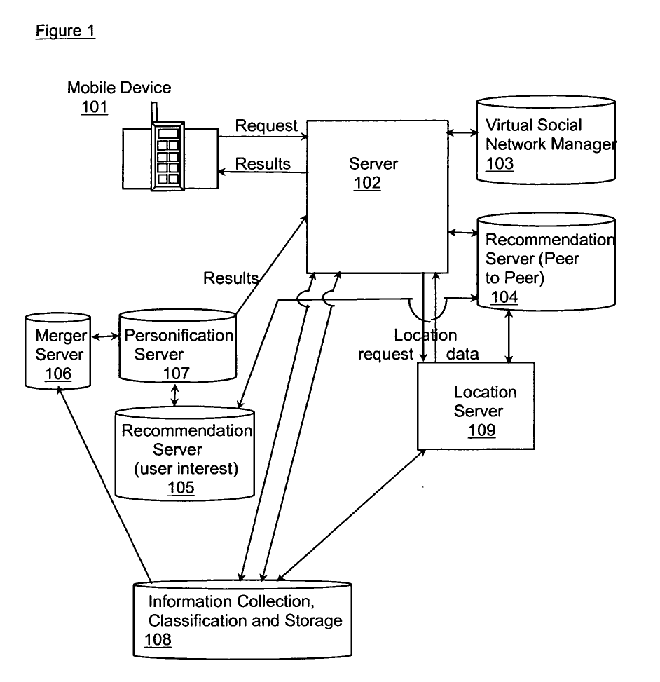

FIG. 1 represents a search system according to one embodiment of the present invention. Referring to FIG. 1, there is shown a mobile device 101, for example: mobile phone, a small computer, handheld PDA (Personal Digital Assistant), etc.,, a server 102, a virtual social network manager 103, a recommendation server (Peer to Peer) 104, a recommendation server (user interest) 105, a merger server 106, a personification server 107, Information Collection, Classification and Storage Manager 108, a location server 109.

The location server 109 detects the mobile device's geographical location on a frequent basis. When the user wishes to search a resource, the user enters/speaks the search string into the mobile device 101 and thus invokes the search process. When the search process is invoked, the search data is transmitted to the server 102 via a protocol such as HTTP(Hyper Text Transfer Protocol). According to one embodiment, the server 102 interacts with the recommendation server 104 to get recommendations from other users present in the same location at that given time. Thus the user can easily and more efficiently make an informed decision about the searched resource.

According to one embodiment, Information Collection, Classification and Storage Manager 108 contains periodically collected, updated and classified data. This data is collected from sources such as Internet web pages, client organizations' Web Services, manual entries, etc. This data is classified and integrated with the location and map information provided by the location server 109.

According to one embodiment, the merger server 106 interacts with the Information Collection, Classification and Storage Manager 108 and also with the recommendation server (user interest) 105 and the personification server 107 and the final search results are constructed. These search results are then transmitted back to the server 102. The recommendation server 104 matches user's interest and previous transaction details to searched results and provides recommendations accordingly. The Virtual Social Network Manager 103 interacts with the Server 102 to further refine the results based on user's social network. The merger server 106 is responsible for merging all this information together. According to one embodiment, the personification server 107 stores user's personal information, preferences and previous transaction data, thus helping in customizing the search results.

According to one embodiment, a numerical probabilistic value is calculated based on factors such as availability of the resource during periodic data collection, availability of the resource category in the specified location, other user's recommendations, etc. This probabilistic value is then assigned to the merged information. The search results are sorted based on this value and then returned to the user. According to one embodiment, various other probabilities may be calculated to create a database that can answer complex queries about location, categories and resource information.

According to one embodiment, the server 102 interacts with virtual social network manager 103 to create user profile and query customized social network. The server 102 also interacts with the Information Collection, Classification and Storage Manager 108 to fetch the user profile and network creation related data.

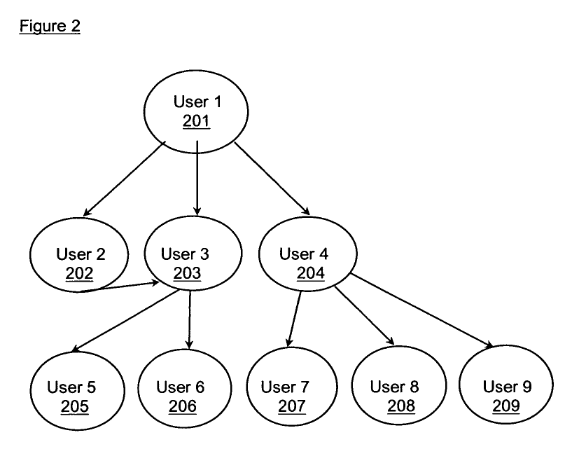

FIG. 2 is an example of dynamically created virtual social network. Referring to FIG. 2, there is shown User 1 201 who represents the user that initiated a resource query. Based on the searched resource, User 1's Interests and past interactions with other users of similar background or with interest in the searched resource, server dynamically creates User 1's trust network. Referring to figure, this network is represented by User 2 202, user 3 203 and User 4 204. Each of these users in turn have their trust networks: User 2's trust network consists of User 3 203, User 3's trust network consists of User 5 205, User 6 206 and User 4's trust network consists of User 7, User 8 208, User 9 209.

Exemplary Operations in Accordance With Embodiments of the Present Invention

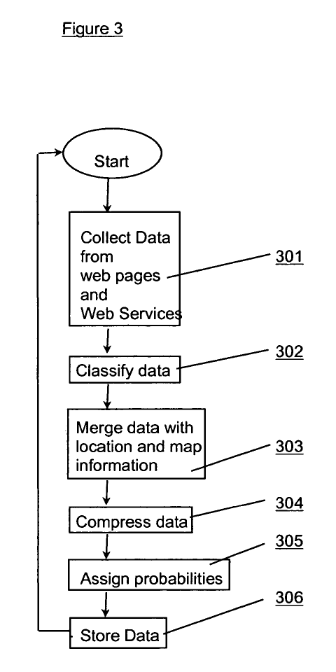

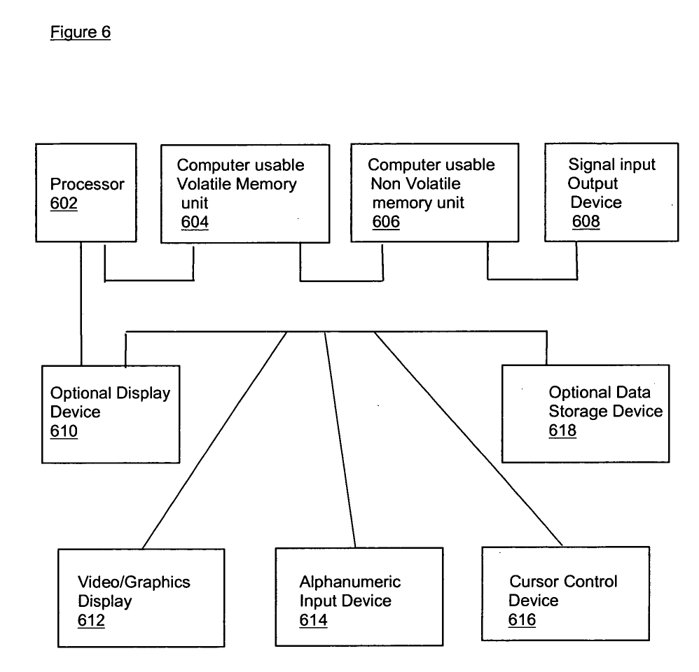

FIGS. 3 to 5 are flowcharts of computer implemented steps performed in accordance with one embodiment of the present invention for providing a method or a system for searching location based information on a mobile device. The flowcharts include processes of the present invention, which, in one embodiment, are carried out by processors and electrical components under the control of computer readable and computer executable instructions. The computer readable and computer executable instructions reside, for example, in data storage features such as computer usable volatile memory (for example: 604 and 606 described herein with reference to FIG. 6). However, computer readable and computer executable instructions may reside in any type of computer readable medium. Although specific steps are disclosed in the flowcharts, such steps are exemplary. That is, the present invention is well suited to performing various steps or variations of the steps recited in FIGS. 3 to 5. Within the present embodiment, it should be appreciated that the steps of the flowcharts may be performed by software, by hardware or by any combination of software and hardware.

The Search Engine—Prefetching/Retrieving Search and Location Data

FIG. 3 consists of the steps performed by the search engine in order to prefetch/retrieve search and location data according to one embodiment of the present invention. Referring to FIG. 3, at step 301, the data is collected from the web pages and Web Services and given to the classifier for keyword and semantics based classification in step 302. This data is merged with maps and location based information along with recommendation data and trust network related data in step 303. The resultant data is then compressed in step 304. Numeric probabilistic values are assigned to the data in step 305. The data is subsequently stored in storage servers in step 306.

The Search Engine—Retrieve and Display Search Results

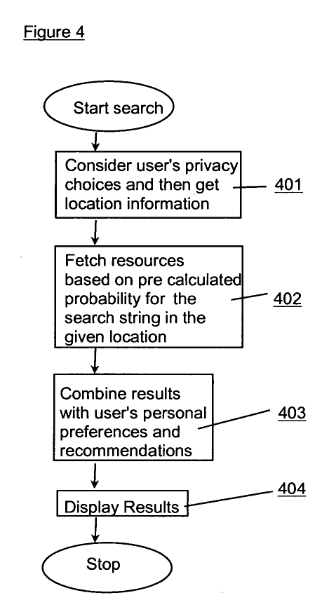

FIG. 4 consists of the steps performed by the search engine after the user has entered the search string. In step 401, after considering the user's privacy choices, the location of the mobile device is detected and all the location specific data is retrieved from the storage server. In step 402, the retrieved data is processed based on the probabilities of finding the specified resource in the given location. These results are combined/refined with user preferences and other users (in the location based peer network and the virtual social network) recommendations in step 403. In step 404, the results are transmitted to the mobile device and displayed.

Search Engine Recommendation System

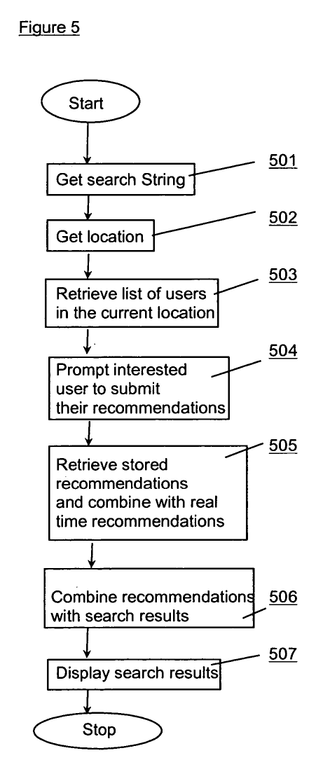

FIG. 5 consists of the steps performed by the dynamic and Peer-to-Peer recommendation system. In step 501, the search string is retrieved from the mobile device and in step 502, the location of the mobile device is detected. In step 503, list of all users in the current location is retrieved from the location server. Each user profile is then checked for recommendations' related privacy preferences. The users interested and having the relevant expertise are prompted to input their recommendations in step 504. The archived recommendations are retrieved and then aggregated with the real time recommendations in step 505. In step 506, the aggregated recommendations are combined with the search results. The search results are displayed in step 507.

Exemplary Hardware in Accordance With Embodiments of the Present Invention

FIG. 6 is a block diagram of an embodiment of an exemplary computer system 600 used in accordance with the present invention, It should be appreciated that the system 600 is not strictly limited to be a computer system. As such, system 600 of the present embodiment is well suited to be any type of computing device (for example: server computer, portable computing device, mobile device, embedded computer system, etc.).

Within the following discussions of the present invention, certain processes and steps are discussed that are realized, in one embodiment, as a series of instructions(for example: software program) that reside within computer readable memory units of computer system 600 and executed by a processor(s) of system 600. When executed, the instructions cause computer 600 to perform specific actions and exhibit specific behavior that is described in detail below.

Computer system 600 of FIG. 6 comprises an address/data bus 610 for communicating information, one or more central processors 602 couples with bus 610 for processing information and instructions. Central processing unit 602 may be a microprocessor or any other type of processor. The computer 600 also includes data storage features such as a computer usable volatile memory unit 604 (for example: random access memory, static RAM, dynamic RAM, etc.) couple with bus 602, a computer usable non-volatile memory unit 606 (for example: read only memory, programmable ROM, EEPROM, etc.) coupled with bus 610 for storing static information and instructions for processor(s) 602. System 600 also includes one or more signal generating and receiving devices 608 coupled with bus 610 for enabling system 600 to interface with other electronic devices. The communication interface(s) 608 of the present embodiment may include wired and/or wireless communication technology. For example, in one embodiment of the present invention, the communication interface 608 is a serial communication port, but could also alternatively be any of a number of well known communication standards and protocols, for example: Universal Serial Bus (USB), Ethernet, FireWire(IEEE 1394), parallel, small computer system interface(SCS), infrared (IR) communication, Bluetooth wireless communication, broadband, and the like.

Optionally, computer system 600 can include an alphanumeric input device 614 including alphanumeric and function keys coupled to the bus 610 for communicating information and command selections to the central processor(s) 602. The computer 600 can include an optional cursor control or cursor directing device 616 coupled to the bus 610 for communicating user input information and command selections to the central processor(s) 602. The system 600 can also include a computer usable mass data storage device 618 such as a magnetic or optional disk and disk drive (for example: hard drive or floppy diskette) coupled with bus 610 for storing information and instructions. An optional display device 612 is coupled to bus 610 of system 600 for displaying video and/or graphics.

As noted above with reference to exemplary embodiments thereof, the present invention provides a method and system for searching location based information on a mobile device. The method and system provides for location based resource information retrieval, processing retrieved resource information based on probability of finding them in the given location, a Peer to Peer recommendation system which combines other user's real time recommendations with archived recommendations, a virtual social network that creates a dynamic network consisting of user and user's acquaintances for refining the resource information in the search result.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of invention and its practical application, to thereby enable others skilled in the art to best utilize the invention and various embodiments with various modifications as are suited to the particular use contemplated. It is intended that the scope of the invention to be defined by the claims appended hereto and their equivalents.

What is claimed is:

1. A method comprising:
a retrieval method for resource information based on location, wherein a a resource may be, but is not limited to a product, a product category, a person, a tourist place, an organization, geographic location or other variations;
a virtual social network filter for refining the resource information;
a method for processing and displaying retrieved resource information based on factors such as probability assigned to the resource, whereby a user can make informed location specific decisions; and
a method for creating dynamic location based peer networks to provide resource recommendations and opinions.

2. The method of claim 1, wherein the resource information is pre-fetched and updated periodically from sources such as Internet web pages, organizations' Web Services, manual entries, etc.

3. The method of claim 1, wherein numeric probabilities are assigned to the resource information and then periodically updated depending on factors such as resource's availability in the given location.

4. The method of claim 3, wherein the search results are sorted and displayed based on resource's numeric probability in the given location.

5. The method of claim 1, wherein the said recommendations may be provided live, or with values stored earlier by other mobile device users which are in user's location based peer network.

6. The method of claim 5, wherein the said recommendations combine other user's real time recommendations with archived recommendations.

7. The method of claim 5, wherein some reward may be provided to the user providing live recommendation. The reward is not limited to a point system, virtual currency, virtual credit, actual credit, actual currency or any other similar system.

8. The method of claim 1 wherein the said recommendations are combined with the probabilities assigned to the resources whereby the user is provided with a sorted set of results with the first result being most available and popular in the current location, and is based on user's preferences and user specified interests.

9. The method of claim 1, wherein the said recommendation system checks user's privacy preferences before retrieving/providing recommendations from or to a user.

10. The method of claim 1, wherein the said virtual social network is a virtual network comprising of user, users' trusted acquaintances, users with similar interests and in turn their trusted acquaintances.

11. The method of claim 10, wherein based on user's choice, the social network can be formed by the user or can be selected by a computer program so as to reflect the user profile and user's current and archived queries' context.

12. The method of claim 10, wherein trust is defined as a quantitative value that is an aggregation of user's past interaction experience with that particular acquaintance.

13. The method of claim 12, wherein user can specify trust to be limited to certain resource categories and certain trust value range.

14. The method of claim 12, wherein users with high trust level of trust and having high level of expertise on the resource's subject matter are chosen to form the dynamic social network that filters the search results by providing an opinion about the resource.

15. The method of claim 1, wherein resource images are used to assist users to narrow down results with the means of visualization.

16. The method of claim 2, wherein the web pages are classified to indicate the opinion expressed by the web page.

17. The method of claim 15, wherein the opinion is obtained by parsing the web page to establish a correlation between a resource and the opinion expressed.

18. The method of claim 16, wherein the opinion obtained and the numeric weights assigned to web page classification are recalculated and re-classified based on the social network opinion.

19. The method of claim 1, where the resource is identified as location specific or one with global relevance and then the dynamic peer networks/social networks are formed.

20. The method of claim 1, where both the virtual social network and the dynamic Location based peer group work as decision support system for a particular resource.
